(19) United States
(12) Patent Application Publication
(10) Pub. No.: US 2009/0201280 A1
(43) Pub. Date: Aug. 13, 2009

(54) Image display system

(75) Inventor: Sheng Feng Huang, Miaoli City (TW)

Correspondence Address: LIU & LIU, 444 S. FLOWER STREET, SUITE 1750, LOS ANGELES, CA, 90071, US

(73) Assignee: TPO Displays Corp., Chu-Nan (TW)

(21) Appl. No.: 12/322,179

(22) Filed: Jan. 28, 2009

(30) Foreign Application Priority Data
Jan. 31, 2008 (TW) 097103672

(51) Int. Cl. G09G 5/00

(52) U.S. Cl. 345/211

(57) ABSTRACT

The present invention provides an image display system that includes a charge pump circuit. The charge pump circuit further includes a first inverter, a first switch, and a capacitor. The first inverter has a first input terminal and a first output terminal. The first input terminal receives a first clock signal with a first voltage swing and the first output terminal outputs the first inverse clock signal by inversely converting the phase of the first clock signal. The first switch has a first switch input terminal, a first control terminal and a first switch output terminal. The first input terminal receives an input voltage. The first control terminal is coupled to the first output terminal and controls the first switch according to the first inverse clock voltage signal. A terminal of the capacitor receives a second clock signal with a second voltage swing and the other terminal of the first capacitor is coupled to the first switch output terminal to provide the first output voltage.

### CROSS REFERENCE TO RELATED APPLICATIONS

This application claims the right of priority based on Taiwan Patent Application No. 097103672 entitled “IMAGES DISPLAY SYSTEM”, filed on Jan. 31, 2008, which is incorporated herein by reference and assigned to the assignee herein.

### FIELD OF THE INVENTION

The present invention is related to an image display system, and more particularly to an image display system adopting a charge pump circuit having an inverter.

### BACKGROUND OF THE INVENTION

In general, an image display system adopts a charge pump circuit to achieve a required voltage level. For instance, FIG. 1A shows an exemplary circuit, which provides a voltage level shifting to have the output voltage as four times the input voltage. The circuit includes four P-type MOSFET switches N1-N4, four switch control circuits 2, 4, 6, 8 of the level shifter, and three capacitors 2′, 4′, 6′. By receiving a first clock signal CLK1 and a second clock signal CLK2 simultaneously, the level shifters 2, 4, 6, 8 control the switches N1-N4. In response to ON and OFF of the switches N1-N4 and the first clock signal CLK1 and the second clock signal CLK2, the output terminal OUT outputs voltage as four times the input voltage IN.

FIG. 1B shows the level shifter 2, 4, 6, 8. Each level shifter 2, 4, 6, or 8 consists of N-type MOSFET NMOS1, NMOS2 and P-type MOSFET PMOS1 and PMOS2. When the charge pump circuit is going to output the positive voltage output, P-type MOSFET switches N1 and N3 are ON, but P-type MOSFET switches N2 and N4 are OFF during the first half period of the first clock signal CLK1. Meanwhile, the first clock signal CLK1 becomes the low-level voltage and the clock signal CLK2 becomes the high-level voltage. A capacitor 4′ placed between a node N22 and the second clock signal CLK2 stores a voltage as the sum of a voltage at a node N11, an input voltage IN, and a voltage of the first clock signal CLK1. Then during the second half period of the first clock signal CLK1, the P-type MOSFET switches N1 and N3 (as shown in FIG. 1A) are OFF, but the P-type MOSFET switches N2 and N4 are ON. When the charge pump which consists of the level shifter 2, 4, 6, 8 reaches a stable state, a output voltage from the P-type MOSFET switch N4 achieves four times the input voltage IN.

However, one of the level shifters 2, 4, 6, 8 has to receive simultaneously the first clock signal CLK1 and the second clock signal CLK2. Meanwhile, the level shifters 2, 4, 6, 8 has to rely on four control switch circuits, and each control switch circuit consists of a N-type MOSFET and a P-type MOSFET respectively. In addition, a high-level voltage VH and a low-level voltage VL should be provided with the level shifters to control the P-type MOSFET switches N1-N4 to turn ON and OFF.

Therefore it is desirable to improve the drawback of the conventional charge pump circuit. The present invention has advantages such as power saving, simple manufacturing, lower cost, and fewer components.

### SUMMARY OF THE INVENTION

The present invention is to provide an image display system having a charge pump which is provided to output a higher voltage than the input voltage.

One aspect of the present invention is to provide an image display system that includes a charge pump circuit. The charge pump circuit further includes a first inverter, a first switch, and a capacitor. The first inverter has a first input terminal and a first output terminal. The first input terminal receives a first clock signal with a first voltage swing and the first output terminal outputs the first inverse clock signal by inversely converting the phase of the first clock signal. The first switch has a first switch input terminal, a first control terminal and a first switch output terminal. The first input terminal receives an input voltage. The first control terminal is coupled to the first output terminal and controls the first switch according to the first inverse clock voltage signal. A terminal of the capacitor receives a second clock signal with a second voltage swing and the other terminal of the first capacitor is coupled to the first switch output terminal to provide the first output voltage.

Another aspect of the present invention is to provide an image display system that includes a charge pump circuit. The charge pump circuit further includes a first inverter, a second inverter, a first switch, a second switch, a first capacitor, and a second capacitor. The first inverter has a first input terminal and a first output terminal. The first input terminal receives a first clock signals with a first voltage swing and the first output terminal outputs a first inverse clock signal by inversely converting the phase of the first clock signal. The second inverter has a second input terminal and a second output terminal. The second input terminal receives a second clock signal with a second voltage swing and the second output terminal outputs a second inverse clock signal by inversely converting the phase of the second clock signal. The first switch has a first switch input terminal, a first control terminal, and a first switch output terminal. The first switch input terminal receives the input voltage. The first control terminal is coupled to the first output terminal and controls the first switch according to the first inverse clock voltage signal. A terminal of the first capacitor receives a second clock signal with a second voltage swing and the other one terminal of the first capacitor is coupled to the first switch output terminal to provide the first output voltage. The second switch has a second switch input terminal, a second control terminal, and a second switch output terminal. The second switch input terminal receives a voltage of the first capacitor. The second control terminal is coupled to the second output terminal and controls the second switch according to the second inverse clock voltage signal. The terminal of the second capacitor receives the first clock signal with a first voltage swing and the other one terminal of the second capacitor is coupled to the second switch output terminal to provide the second output voltage.

The foregoing and other features of the invention will be apparent from the following detailed description of embodiments of the invention.

### BRIEF DESCRIPTION OF THE DRAWINGS

The present invention is illustrated by way of example and not intended to be limited by the figures of the accompanying drawing, in which like notations indicate similar elements.

FIG. 1A illustrates an exemplary circuit of the level shifter of the conventional charge pump circuit;

FIG. 1B further illustrates the detailed circuit of the level shifter in the FIG. 1A;

FIG. 2A illustrates a charge pump circuit of an image display system according to one embodiment of the present invention;

FIG. 2B illustrates the first inverter of the charge pump circuit according to the embodiment of the present invention;

FIG. 2C illustrates a sequence diagram according to the embodiment of the present invention in the FIG. 2B;

FIG. 3A illustrates a charge pump circuit of an image display system according to another embodiment of the present invention;

FIG. 3B illustrates the charge pump circuit of the image display system according to the embodiment of the present invention in the FIG. 3A;

FIG. 3C illustrates the charge pump circuit of the image display system according to the embodiment of the present invention in the FIG. 3B;

FIG. 3D illustrates the charge pump circuit of the image display system according to the embodiment of the present invention in the FIG. 3C;

FIG. 3E illustrates the charge pump circuit of the image display system according to the embodiment of the present invention in the FIG. 3D; and

FIG. 4 illustrates a charge pump circuit of an image display system according to another embodiment of the present invention.

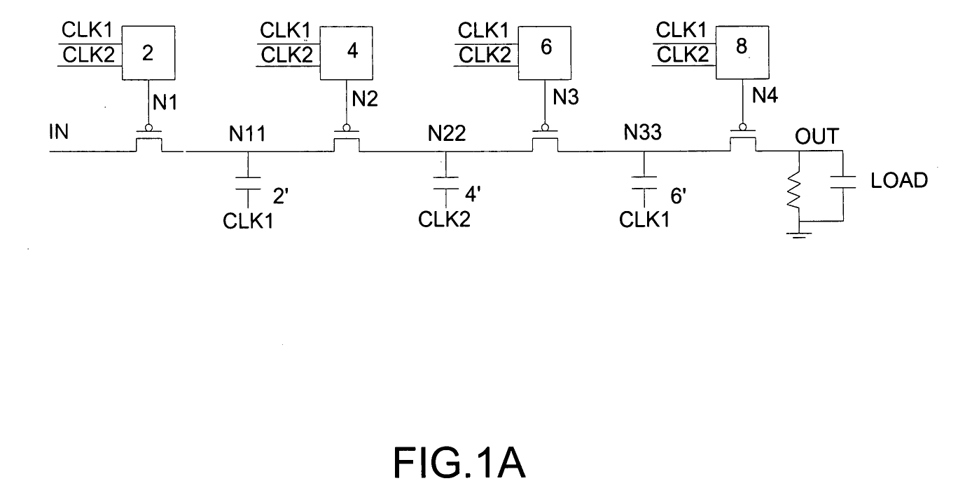

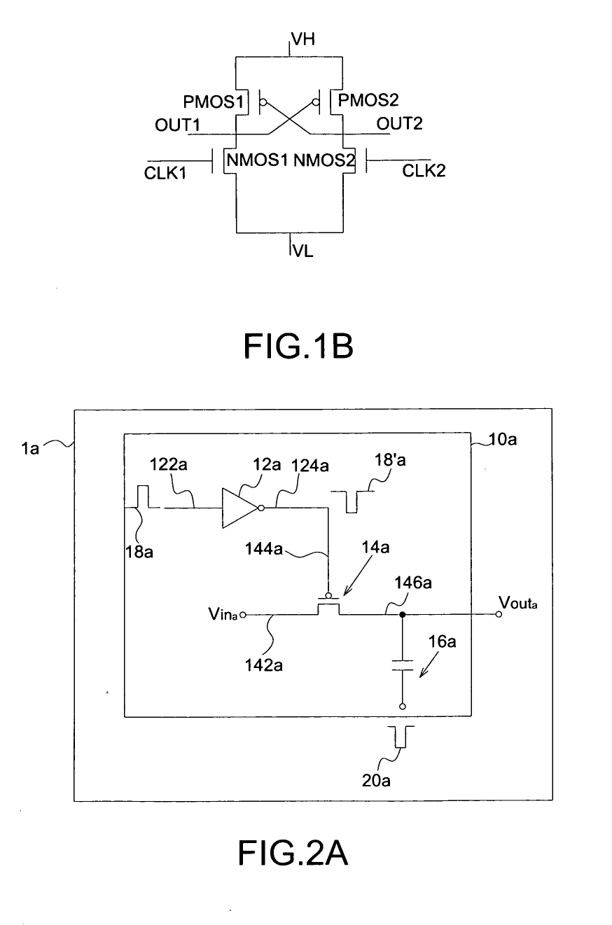

### DETAILED DESCRIPTION OF THE INVENTION

As follows, the invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of present invention. Benefits, other advantages, and solutions to problems have been described above with regard to specific embodiments.

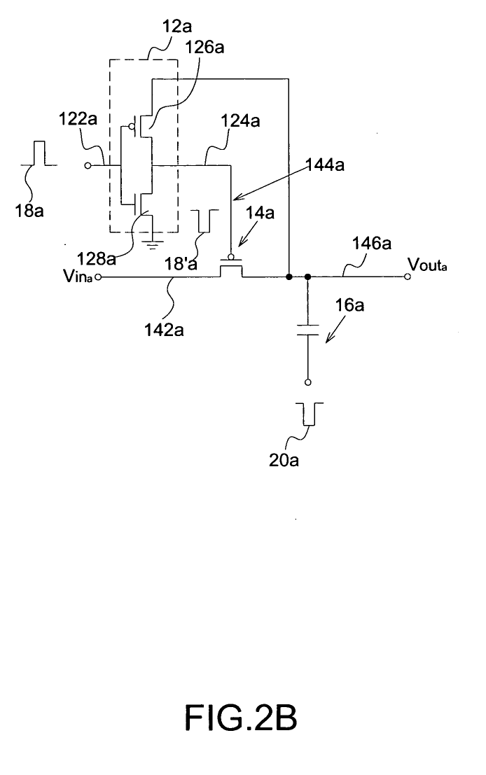

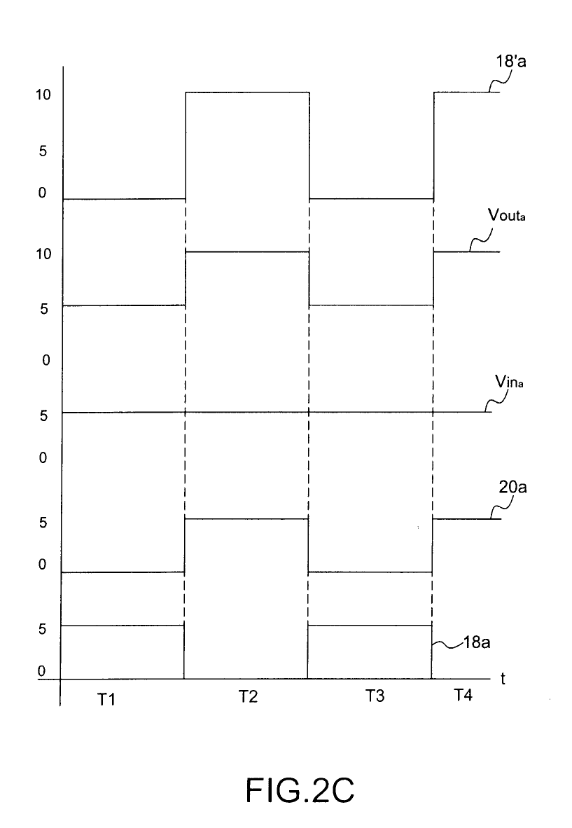

FIG. 2A is a schematic diagram illustrating a charge pump circuit 10a of an image display system 1a according to one embodiment of the present invention. The image display system 1a may include a mobile phone, a digital camera, a personal digital assistant (PDA), a notebook computer, a desktop computer, a television, a car media player, a portable video player, a GPS device, an avionics display or a digital photo frame.

In this embodiment, the charge pump circuit 10a includes a first inverter 12a, a first switch 14a, and a first capacitor 16a. The first inverter 12a has a first input terminal 122a and a first output terminal 124a. The first input terminal 122a receives a first clock signal 18a with a first voltage swing. The first output terminal 124a outputs a first inverse clock signal 18′a by inversely converting the phase of the first clock signal 18a.

Each period of the first clock signal 18a comprises a positive half period with a high-level voltage and a negative half period with a low-level voltage. Consequently, the first inverse clock signal 18′a is at the low-level voltage when the first clock signal 18a is at the high-level voltage. The first inverse clock signal 18′a becomes a high-level voltage when the first clock signal changes to the low-level voltage.

The first switch 14a has a first switch input terminal 142a, a first control terminal 144a, and a first switch output terminal 146a. The first switch input terminal 142a receives an input voltage Vina. The first control terminal 144a is coupled to the first output terminal 124a and controls the first switch 14a to turn ON or OFF the first switch input terminal 142a and the first switch output terminal 146a of the first switch 14a according to the first inverse clock signal 18′a. One terminal of the first capacitor 16a receives a second clock signal 20a with the second voltage swing and the other terminal is coupled to the first switch output terminal 146a to provide a first output voltage Vouta.

The first clock signal 18a and the second clock signal 20a are square waves with the same pulse width. Meanwhile, each period of the second clock signal 20a is divided into a positive half period with a high-level voltage and a negative half period with a low-level voltage. In an embodiment, the first clock signal 18a and the second clock signal 20a are square waves with the same pulse width but inverse phases. For example, the second clock signal 20a is at the low-level voltage when the first clock signal 18a is at the high-level voltage, and vice versa. Accordingly, the second clock voltage signal 20a and the first inverse clock signal 18′a have the same pulse width and the same phase.

During the positive half period of the first clock signal 18a, the first clock signal 18a is at the high-level voltage and the first inverse clock signal 18′a that the first inverter 12a provides with the first control terminal 144a is at the low-level voltage. When the first switch 14a is open (or short-circuit), the input voltage Vina received from the first switch terminal 142a appears at the first switch output terminal 146a. At present, the positive half period of the second clock signal 20a is just at the low-level voltage, and it makes the first capacitor 16a store the same voltage as the input voltage Vina. Namely, the first capacitor 16a is charged with the input voltage Vina.

During the negative half period of the first clock signal 18a, the first clock signal 18a is at the low-level voltage and the first inverse clock signal 18′a that the first inverter 12a provides with the first control terminal 144a is at the high-level voltage. When the first switch 14a is close (or open-circuit), the input voltage Vina cannot arrive at the first switch output terminal 146a. At this time, the first output voltage Vouta of the first switch output terminal 146a of the first switch 14a is the sum of the stored voltage of the capacitor 16a and the second voltage of the second clock signal 20a.

FIG. 2B illustrates the first inverter 12a of the charge pump circuit 10a according to the embodiment of the present invention. In this embodiment, the first inverter 12a further includes a first P-type Metal-Oxide-Semiconductor Field-Effect Transistor (MOSFET) 126a and a N-type MOSFET 128a. A gate of the first P-Type MOSFET 126a is coupled to a gate of the N-type MOSFET 128a, and both of them receive the first clock signal 18a at the same time. A source of the P-type MOSFET 126a is coupled to the first switch output terminal 146a, and the source receives the first output voltage Vouta of the first switch 14a. Namely, when the gate of P-type MOSFET 126a receives the first clock signal 18a at the high-level voltage, the first P-type MOSFET 126a is close (or open-circuit) and the N-type MOSFET is open (or short-circuit), wherein the source/drain of the N-type MOSFET 128a is directly connected to ground and the output voltage of the first output terminal 124a is the grounded voltage. Then the first P-type MOSFET 126a is open (or short-circuit) and the N-type MOSFET is close (or open-circuit) in response to the output voltage of the first output terminal 124a, and the first switch output terminal 146a outputs the first output voltage Vouta. Particularly, the first output voltage Vouta of the first switch output terminal 146a is the sum of the input voltage Vina and the second voltage of the second clock signal 20a.

FIG. 2C is a schematic diagram representing a sequence illustrating the image display system according to the embodiment of the present invention in the FIG. 2B. In this embodiment, the time t is denoted in the horizontal axis and the voltage v is shown in the vertical axis. A complete period of the square wave includes a positive half period T1 (or T3) and a negative half period T2 (or T4) in FIG. 2C.

During the first positive half period T1, the first input terminal 122a of the first inverter 12a receives the first clock signal 18a at 5 V, and the first inverter 12a generates a first inverse clock signal 18′a by inversely converting the phase of the first clock signal 18a. The first control terminal 144a of the first switch 14a is open (or short-circuit) in response to the first inverse clock signal 18′a. Meanwhile, a terminal of the first capacitor 16a receives the second clock signal 20a at 0 V, which has the inverse phase with the first clock signal 18a. Similarly, the first switch input terminal 142a receives the input voltage Vina at 5 V during the first positive half period T1. The first capacitor 16a is charged with the input voltage Vina and then has the same voltage as the input voltage Vina. At this time, the first output voltage Vouta at 5 V of the first switch output terminal 146a is the sum of the first capacitor 16a at 5 V and the second voltage of the second clock signal 20a at 0 V.

During the first negative half period T2 that comes after the period T1, the second clock signal 20a becomes a high-level voltage at 5 V and raises the first output voltage Vouta of the first switch output terminal 146a to 10 V, which is higher than the input voltage. During the first negative half period T2, the first clock signal 18a becomes a low-level voltage. The P-type MOSFET 126a is open (or short-circuit), and the first input voltage Vouta at 10 V directly appears at the first output terminal 124a and makes the first switch 14a close. Accordingly, the first output voltage Vouta at 10 V of the first switch output terminal 146a is the sum of the input voltage at 5 V of the first capacitor 16a and the second voltage at 5 V of the second clock signal 20a.

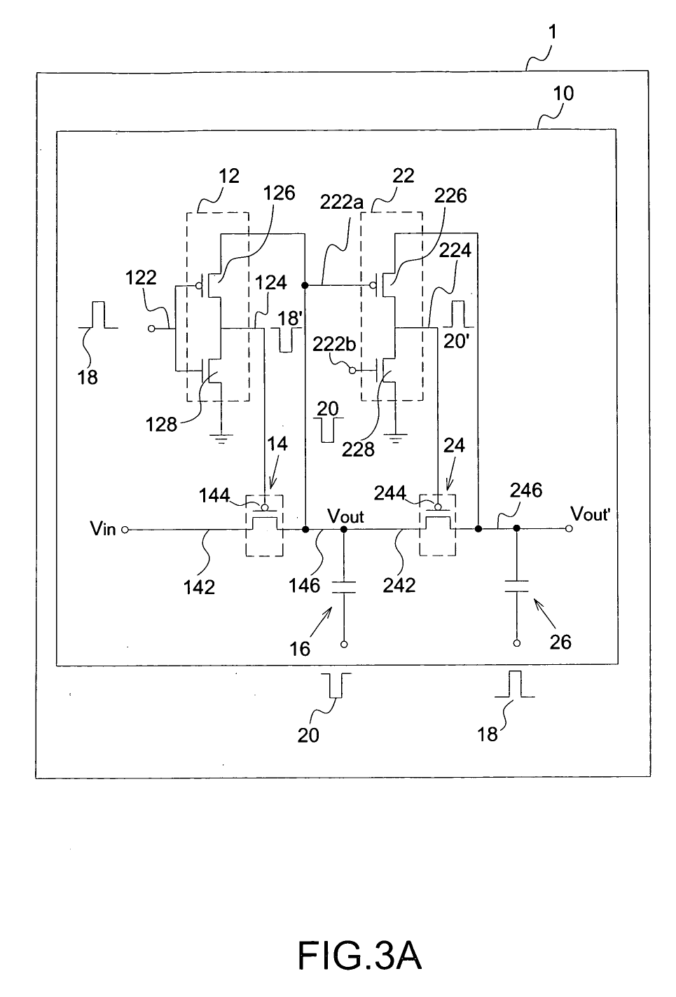

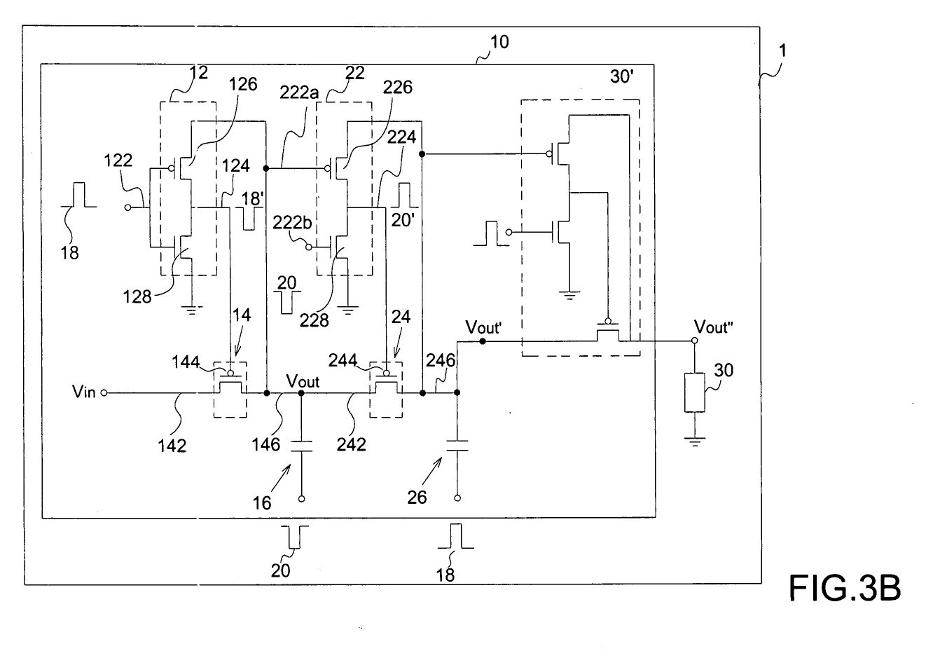

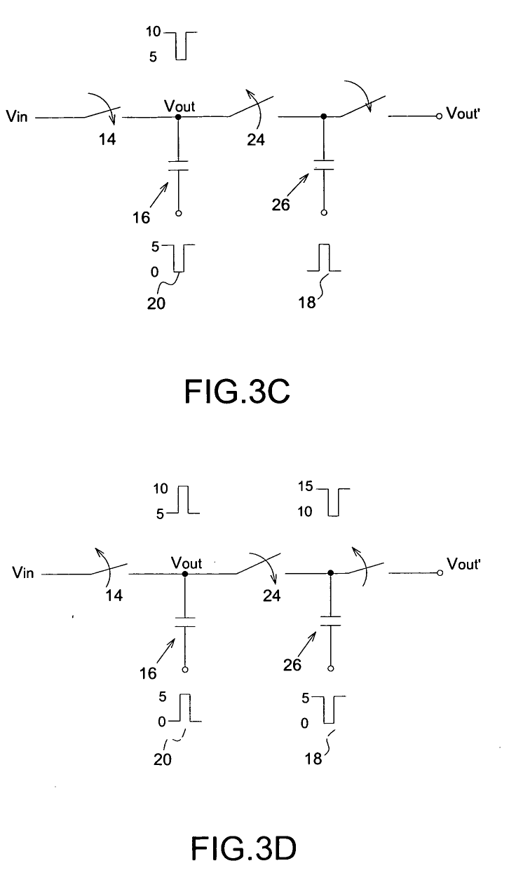

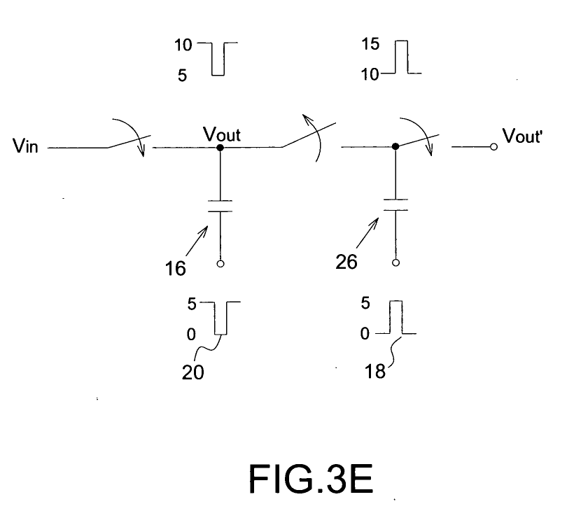

FIG. 3A is a schematic circuit diagram illustrating a charge pump circuit 10 of an image display system 1 according to another embodiment of the present invention. The image display system 1 may include a mobile phone, a digital camera, a personal digital assistant (PDA), a notebook computer, a desktop computer, a television, a car media player, a portable video player, a GPS device, an avionics display or a digital photo frame.

In this embodiment, the charge pump circuit 10 includes a first inverter 12, a second inverter 22, a first switch 14, a second switch 24, a first capacitor 16, and a second capacitor 26. The first inverter 12 has a first input terminal 122, and a first output terminal 124. The first input terminal 122 receives a first clock signals 18 with a first voltage swing and the first output terminal 124 outputs a first inverse clock signal 18′ by inversely converting the phase of the first clock signal 18. The second inverter 22 has two second input terminal 222a, 222b and a second output terminal 224. The second input terminal 222b receives a second clock signal 20 with a second voltage swing and the second output terminal 224 outputs a second inverse clock signal 20′ by inversely converting the phase of the second clock signal 20. The first switch 14 has a first switch input terminal 142, a first control terminal 144, and a first switch output terminal 146. The first switch input terminal 142 receives the input voltage Vin. The first control terminal 144 is coupled to the first output terminal 124 and controls the first switch 14 according to the first inverse clock voltage signal 18′. The second switch 24 has a second switch input terminal 242, a second control terminal 244, and a second switch output terminal 246. The second switch input terminal 242 receives the voltage stored in a first capacitor 16. The second control terminal 244 is coupled to the second output terminal 224 and controls the second switch 24 according to the second inverse clock voltage signal 20′. One terminal of the first capacitor 16 receives a second clock signal 20 with a second voltage swing and the other terminal of the first capacitor 16 is coupled to the first switch output terminal 146 to store an output voltage Vout of the first switch output terminal 146. The terminal of the second capacitor 26 receives a first clock signal 18 with a first voltage swing and the other terminal of the second capacitor 26 is coupled to the second switch output terminal 246 to provide a second output voltage Vout′.

In this embodiment, the first inverter 12 further includes a first P-type MOSFET 126 and a first N-type MOSFET 128. The second inverter 22 further includes a second P-type MOSFET 226 and a second N-type MOSFET 228. A gate of the P-type MOSFET 126 is coupled to a gate of the N-type MOSFET 128 and both of them receive the first clock signal 18. A drain of the first P-type MOSFET 126 is coupled to the first switch output terminal 146 and a source of the first P-type MOSFET 126 receives a first output voltage Vout from the first switch output terminal 146. A gate of the second P-type MOSFET is coupled to the first output terminal 146 and receives the first output voltage Vout. A drain of the second P-type MOSFET 226 is coupled to the second switch output terminal 246 and receives a second output voltage Vout′ from the second switch output terminal 246.

FIG. 3B is a schematic circuit diagram illustrating the charge pump circuit 10 of the image display system 1 according to the embodiment of the present invention in the FIG. 3A. In this embodiment, the image display system 1 further includes an output loading 30, and the other components have been almost described as well as in FIG. 3A. The output voltage Vout″ of charge pump circuit 10 outputs a fixed voltage via the switch circuit 30′ according to the second output voltage Vout′ of the second switch output terminal 246. In an embodiment, the charge pump circuit 10 may adopts at least one of the switch circuit 30′ placed between the second switch output terminal 246 and the output loading 30, wherein the output loading 30 may consist of a resistance, a capacitor, an inductance or a combination thereof. Particularly, the second output voltage Vout′ is not equal to the output voltage Vout″, but it is similar to a square waves in FIG. 2C.

FIG. 3C is a schematic diagram illustrating the charge pump circuit 10 of the image display system 1 according to the embodiment of the present invention in the FIG. 3B. The first capacitor 16 is charged with the input voltage Vin at 5 V when the first switch 14 is open (or short-circuit) and the second switch 24 is close (or open-circuit). The first output voltage Vout at 5 V becomes the sum of input voltage Vin at 5 V and the second voltage at 0 V of the second clock signal 20.

FIG. 3D is a schematic diagram also illustrating the charge pump circuit 10 of the image display system 1 in the FIG. 3C according to one embodiment of the present invention in the FIG. 3B. When the first switch 14 is close (or open-circuit), the second switch 24 becomes open (or short-circuit). The first capacitor 16 cannot be charged with the input voltage Vin at 5 V like in FIG. 3C. However, the second voltage of the second clock signal 20 is changed to a high-level voltage at 5 V, and the first output voltage Vout at 10 V is the sum of the input voltage at 5 V stored in the first capacitor 16 already and the second clock signal 20 at 5 V. The sum voltage (or the first output voltage Vout) will be provided as the input voltage of the second switch input terminal 242 of the second switch 24. In addition, the first clock signal 18 is at the low-level voltage at 0 V. The second output voltage Vout′ at 10V is the sum of the first output voltage Vout at 10 V and the first voltage at 0V of the first clock voltage signal 18.

FIG. 3E is another schematic diagram illustrating the charge pump circuit 10 of the image display system 1 in the FIG. 3D according to the embodiment of the present invention in the FIG. 3B. When the first switch 14 is open again (or short-circuit), the second switch 24 will be close (or open-circuit). The first voltage of the first clock signal 18 becomes the high-level voltage at 5 V. The second output voltage Vout′ at 15 V is the sum of the first output voltage at 10 V already stored in the second capacitor 26 and the first voltage at 5 V of the first clock signal 18. Accordingly, the second output voltage Vout′ is higher than the input voltage Vin. In this embodiment, the second output voltage Vout′ at 15 V is three times the input voltage at 5 V.

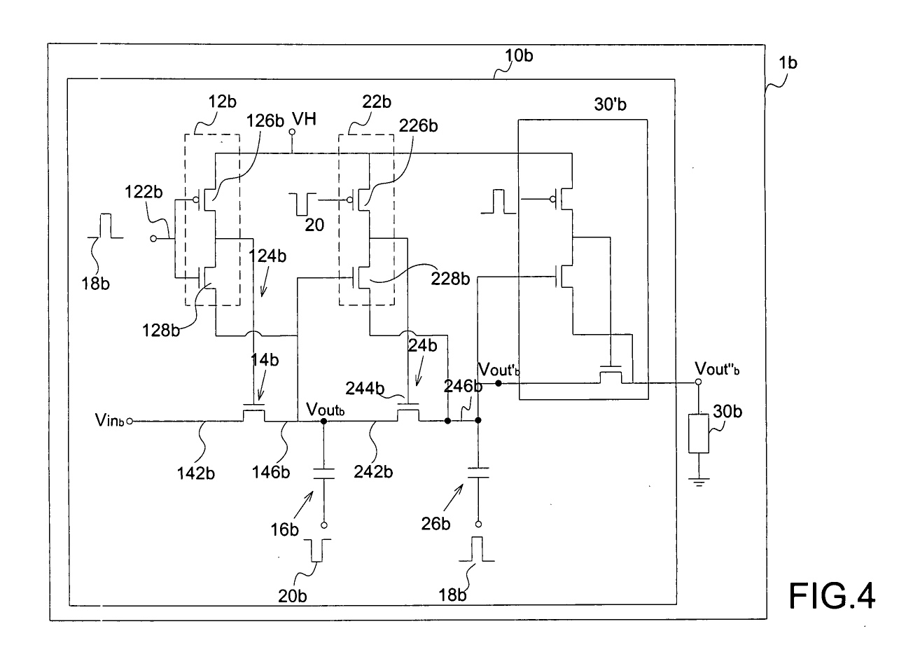

FIG. 4 is a schematic diagram illustrating a charge pump circuit 10b of an image display system 1b according to one embodiment of the present invention. In this embodiment, the above-mentioned P-type MOSFET switches are replaced by N-type MOSFET switches, and the other components are the same as embodiments above. A first inverter 12b include a P-type MOSFET 126b and a N-type MOSFET 128b. A second inverter 22b includes a second P-type MOSFET 226b and a second N-type MOSFET 228b. A gate of the P-type MOSFET 126b is coupled to a gate of the N-type MOSFET 128b and both of them receive the first clock signal 18b. An output terminal (or source) of the N-type MOSFET 128b is coupled to the first switch output terminal 146b and receives a first output voltage Voutb from the first switch output terminal 146b. A drain of the first P-type MOSFET 126b receives a high-level voltage. A gate of the second N-type MOSFET 228b is coupled to the first output voltage Voutb of the first switch output terminal 146b. A drain of the first P-type MOSFET 126b and a source of the second P-type MOSFET 226b both receive a high-level voltage VH. In one embodiment, the charge pump circuit 10b further adopts at least one switch circuit 30′b placed between the second switch output terminal 246b and an output loading 30b. Then, the output voltage Vout″b of charge pump circuit 10b outputs a fixed voltage via the switch circuit 30′b according to the second output voltage Vout′b of the second switch output terminal 246b.

To understand the operating method of the charge pump circuit 10b, those skilled in the art can refer to above-mentioned illustrations from FIG. 3C to FIG. 3E, but note that the second output voltage Vout′b is a negative voltage output.

Compared with the conventional level shift circuit adopting four MOSFETs, the charge pump circuit of the present embodiments only utilizes two MOSFETs. In addition, the charge pump circuits described above have advantages such as power saving, simple manufacturing, lower cost, and fewer components.

While this invention has been described with reference to the illustrative embodiments, these descriptions should not be construed as a limit. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

What is claimed is:

1. An image display system, comprising:
a charge pump circuit, receiving an input voltage and outputting a first output voltage, said charge pump circuit further comprising:
a first inverter having a first input terminal and a first output terminal, said first input terminal receiving a first clock signal with a first voltage swing and said first output terminal outputting a first inverse clock signal by inversely converting the phase of said first clock signal;
a first switch, having a first switch input terminal, a first control terminal and a first switch output terminal, said first switch input terminal receiving said input voltage, said first control terminal being coupled to said first output terminal and controlling said first switch according to said first inverse clock voltage signal; and
a first capacitor, a terminal of said first capacitor receiving a second clock signal with a second voltage swing and the other terminal of said first capacitor being coupled to said first switch output terminal to provide said first output voltage.

2. An image display system according to claim 1, wherein said first clock signal and said second clock signal are square waves with the same pulse width but inverse phases.

3. An image display system according to claim 1, wherein said first capacitor is charged with said input voltage when said first switch is ON.

4. An image display system according to claim 3, wherein said first output voltage is the sum of said input voltage and said second voltage of said second clock signal.

5. An image display system according to claim 1, wherein said first inverter further comprises a first P-type Metal-Oxide-Semiconductor Field-Effect Transistor (MOSFET) and a first N-type MOSFET.

6. An image display system according to claim 5, wherein a gate of said P-type MOSFET of said first inverter is coupled to a gate of said N-type MOSFET of said first inverter, and both of them receive said first clock signal at the same time.

7. An image display system, comprising:
a charge pump circuit, receiving an input voltage and outputting a second output voltage, said charge pump circuit further comprising:
a first inverter having a first input terminal and a first output terminal, said first input terminal receiving a first clock signal with a first voltage swing and said first output terminal outputting a first inverse clock signal by inversely converting the phase of said first clock signal;
a second inverter having a second input terminal and a second output terminal, said second input terminal receiving a second clock signal with a second voltage swing and said second output terminal outputting a second inverse clock signal by inversely converting the phase of said second clock signal;
a first switch, having a first switch input terminal, a first control terminal and a first switch output terminal, said first switch input terminal receiving said input voltage, said first control terminal being coupled to the first output terminal and controlling said first switch according to said first inverse clock voltage signal
a first capacitor, a terminal of said first capacitor receiving said second clock signal and the other terminal of said first capacitor being coupled to said first switch output terminal to provide said first output voltage;
a second switch, having a second switch input terminal, a second control terminal and a second switch output terminal, said second switch input terminal receiving a voltage of said first capacitor, said second control terminal being coupled to the second output terminal and controlling said second switch according to said second inverse clock voltage signal; and
a second capacitor, a terminal of said second capacitor receiving said first clock signal and the other terminal of said second capacitor being coupled to said second switch output terminal to provide said second output voltage.

8. An image display system according to claim 7, wherein said first capacitor is charged with said input voltage when said first switch is ON.

9. An image display system according to claim 8, wherein said second capacitor is charged with a voltage of said first capacitor when said first switch is OFF and said second switch is ON.

10. An image display system according to claim 7, wherein said first inverter further comprises a first P-type MOSFET and a first N-type MOSFET, and a gate of said P-type MOSFET of said first inverter is coupled to a gate of said N-type MOSFET of said first inverter, and both of them receive said first clock signal at the same time.

11. An image display system according to claim 7, wherein said second inverter further comprises a second P-type MOSFET and a second N-type MOSFET.

12. An image display system according to claim 11, wherein a gate of said second P-type MOSFET is coupled to said first capacitor.

13. An image display system according to claim 11, wherein a gate of said second P-type MOSFET receives said first clock signal.

14. An image display system according to claim 11, wherein a gate of said second N-type MOSFET receives said second clock signal.

15. An image display system according to claim 11, wherein a gate of said second N-type MOSFET is coupled to said first capacitor.

16. An image display system according to claim 7, wherein said first switch and said second switch is a P-type MOSFET or a N-type MOSFET.

17. An image display system according to claim 7, wherein said first output voltage is the sum of a voltage of said first capacitor and said first voltage of said first clock signal.

18. An image display system according to claim 7, wherein said second output voltage is the sum of said first input voltage, said second voltage of said second clock signal, and said first voltage of said first clock signal.

19. An image display system according to claim 7, wherein said first clock signal and said second clock signal are square waves with the same pulse width but inverse phases.

20. An image display system according to claim 7, wherein said image display system is a mobile phone, a digital camera, a personal digital assistant (PDA), a notebook computer, a desktop computer, a television, a car media player, a portable video player, a GPS device, an avionics display or a digital photo frame.
